(19) United States
(12) Patent Application Publication
(10) Pub. No.: US 2015/0321374 A1
(43) Pub. Date: Nov. 12, 2015

(54) MULTIFUNCTION CUTTING TOOL GUIDE

(71) Applicants: Michael Ursell, Beverly Hills, MI (US); Garry Favel, Kibbutz Kadarim (IL); Tsvi Hershkovich, Karmiel (IL); Rick Ursell, Rochester Hills, MI (US); Ken Neilson, Troy, MI (US)

(72) Inventors: Michael Ursell, Beverly Hills, MI (US); Garry Favel, Kibbutz Kadarim (IL); Tsvi Hershkovich, Karmiel (IL); Rick Ursell, Rochester Hills, MI (US); Ken Neilson, Troy, MI (US)

(21) Appl. No.: 14/804,545

(22) Filed: Jul. 21, 2015

Related U.S. Application Data
(63) Continuation-in-part of application No. 14/334,940, filed on Jul. 18, 2014.
(60) Provisional application No. 61/847,689, filed on Jul. 18, 2013.
(60) Provisional application No. 61/900,423, filed on Nov. 6, 2013.

(51) Int. Cl. B27B 9/04; B23Q 9/00; B23D 59/00

(52) U.S. Cl. CPC B27B 9/04; B23D 59/00; B23Q 9/0014

(57) ABSTRACT

A multifunction cutting tool guide which includes a base plate having a top surface and a bottom surface, with the base plate top surface including connection points for connecting a power tool to the base plate top surface. A track extends longitudinally along the bottom surface of the base plate for use in guided cuts. The track is defined by first and second spaced walls with at least one of the walls being movable with respect to the other wall to accommodate various sized straight edges. The base also includes a laterally extending channel adapted to mount on a straight edge for rip cuts.

### RELATED APPLICATIONS

This application is a Continuation-In-Part U.S. application Ser. No. 14/334,940 filed Jul. 18, 2014, which claims the benefit of U.S. Provisional Application No. 61/847,689 filed on Jul. 18, 2013 and U.S. Provisional Application No. 61/900,423 filed Nov. 6, 2013.

### STATEMENT REGARDING FEDERALLY SPONSORED RESEARCH

NONE.

### TECHNICAL FIELD

This invention relates generally to power tool guides and more particularly to a versatile multifunctional power tool guide upon, which a power tool can be mounted and then used to guide the power tool to cut material along a straight edge and rip material.

### BACKGROUND OF THE INVENTION

Power tool guides are well known in the wood working industry. Companies, such as for example, Festool, Kreg, True Trac, and Urekazone sell power tool guides. The main problem with each of these tool guides is that they are dedicated to a specific straight edge and cannot be used on other types of straight edges. If a user doesn't have the straight edge required by the specific guide, the user cannot use the guide. This obviously results in the user being limited to a particular guide and a particular edge. Also, some of these guides are for a single purpose.

Other problems with known systems are more specific to each system. The Festool guide system requires a specific track as discussed above, in addition, the Festool system also requires a dedicated circular saw. Only the Festool saw can be used on the system. The Festool system is also very expensive when compared to other guide systems.

The Kreg system requires a specific track and is limited to a ripping function only. It doesn't have the ability to use the track as a guide for making guided cuts without the use of the edge of the material to act as a guide for the guide track.

The True Trac system is limited to a specific track and has the disadvantage of not being capable of doing rip cuts. Additionally, the True Trac requires a special mount that is difficult to mount to the saw. The mount is also intended to be permanently mounted to the saw. The True Trac is will not allow other tools to be used on the track without attaching a separate mount to the tool.

The Eureka Zone system requires a specific track and is not adapted to be used to cut as a straight edge without the use of the material edge as a guide. It is also large and bulky and not east to set up.

### SUMMARY OF THE INVENTION

In general terms, the present invention provides an innovative versatile multifunction saw attachment plate, rail guide and rip attachment that can be used on any straight edge. The present invention solves the problems of known power tool guides and provides a compact, inexpensive, easy to assemble and easy to use solution to guided and rip cutting operations.

The multifunction cutting tool guide of the present invention includes a base plate having a top surface and a bottom surface. The base plate top surface includes connection points for connecting a power tool to the base plate top surface. A track extends longitudinally along the bottom surface of the base plate. The track is defined by first and second spaced walls with at least one of the walls being movable with respect to the other wall.

A power tool can be attached to the base plate and the base plate can be positioned over a straight edge with the straight edge being received within the track of the base plate. The at least one wall is movable against the straight edge with the straight edge engaging the opposite wall. The walls engage both sides of the straight edge such that the base is movable along the straight edge to make a straight cut in a piece of material.

The cutting tool guide system of present invention further includes a channel extending laterally along the bottom surface of the base plate for use in ripping a work piece. The base includes a locking member adapted to lock the base to a rip straight edge. The rip straight edge has a track with a groove extending along the track and a laterally extending rip guide. The channel of the base is positioned over the track and the locking member engages the track to lock the base to the rip straight edge. In the disclosed embodiment, the locking member has a wedge that engages the groove to lock the base plate to the rip straight edge.

The rip straight edge also includes a laterally extending rip guide with a rotatable handle. The rip guide is adapted to engage the edge of the work piece to allow for rip cutting. The handle can be gripped by a user to facilitate rip cutting and can be rotated to avoid the base for cuts of small widths.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a top view of the base plate of the present invention.

FIG. 2 is a bottom view of the base plate of the present invention.

FIG. 3 is a perspective view of a circular saw mounted to the base plate of the present invention.

FIG. 4 is a perspective view of a circular saw mounted to the base plate of the present invention and positioned upon a straight edge for guided cutting.

FIG. 5 is a partial perspective view of a saw mounted upon the base plate and mounted to the rip saw guide system of the present invention.

FIG. 6 is an end view of the rip saw guide of the present invention.

FIG. 7 is a partial top view of the base of the present invention.

FIG. 8 is a partial perspective view of the base plate with a further embodiment of the locking assembly.

FIG. 9 is a partial side view of the base plate and locking assembly in the unlocked position.

FIG. 10 is a partial side view of the base plate and locking assembly in the locked position.

FIG. 11 is a perspective view of the locking assembly in the unlocked position.

FIG. 12 is a perspective view of the locking assembly in the locked position.

### DETAILED DESCRIPTION OF A PREFERRED EMBODIMENT

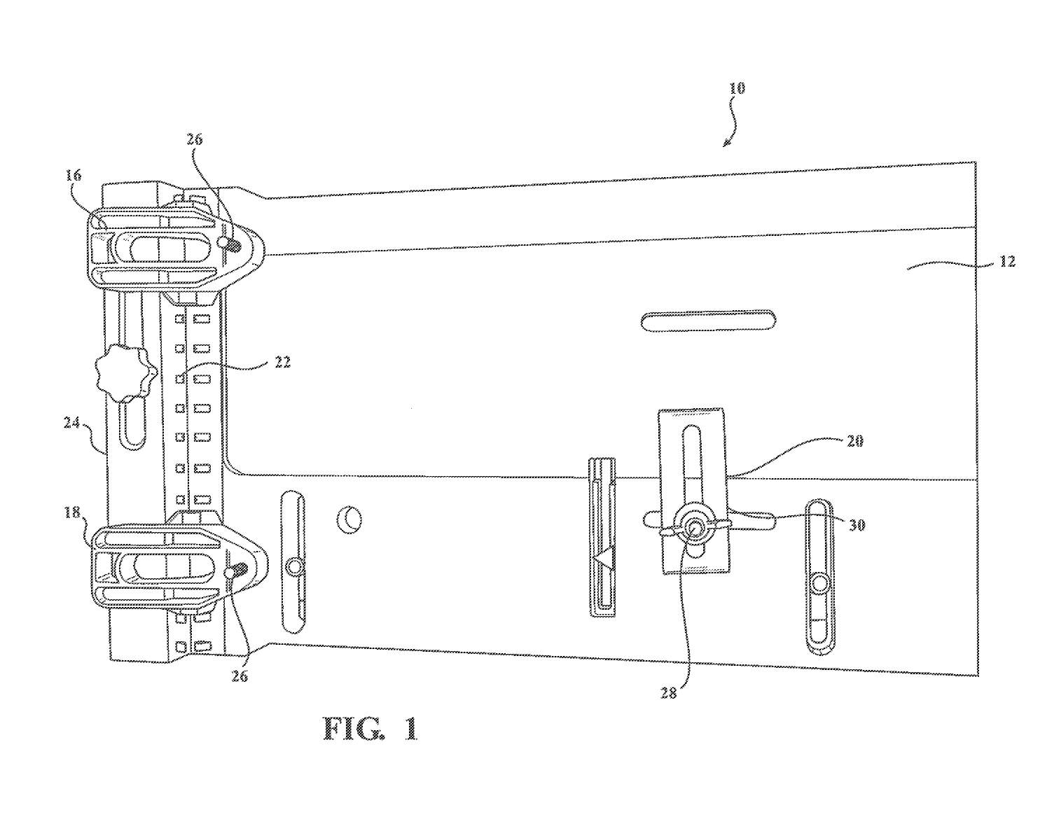

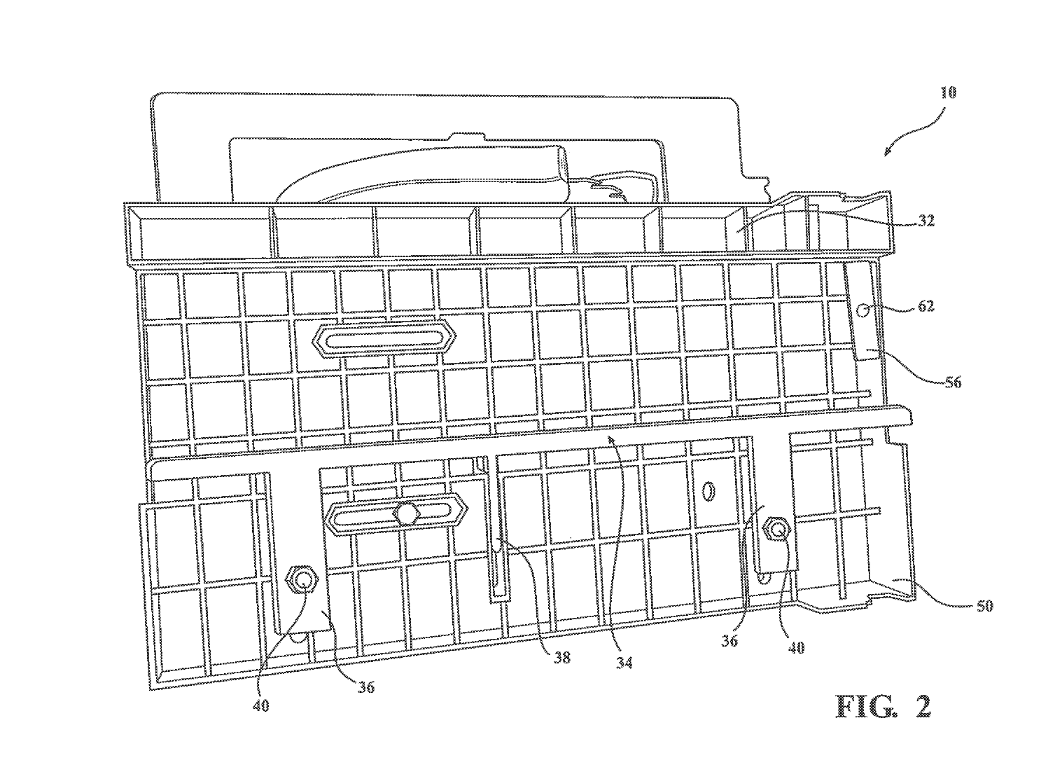

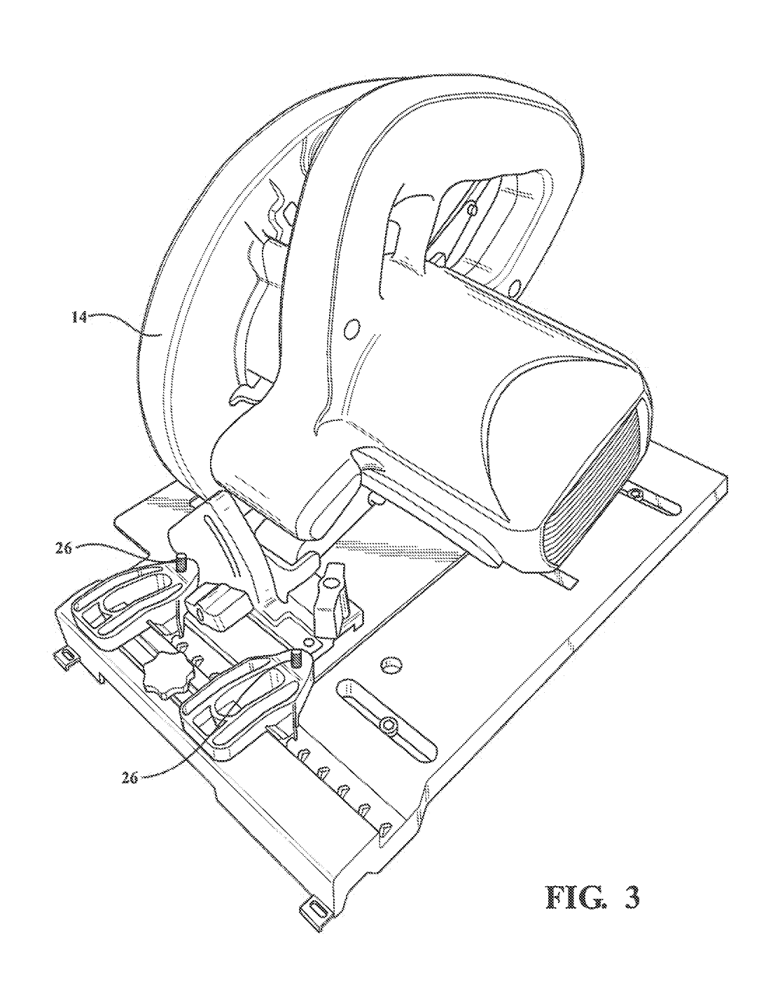

The cutting tool guide of the present invention is shown generally at 10 in FIG. 1. Guide 10 includes a base plate 12. In the disclosed embodiment, the plate is made of molded plastic, however, other materials such as for example aluminum or a combination of aluminum and plastic could be used. Base plate 12 is generally flat and adapted to receive for example a power or cutting tool 14, such as for example a circular saw, jig saw, reciprocating saw, router, etc., see FIG. 3 for an example of a circular saw mounted to the base 12. The base plate 12 includes three connectors at 16, 18 and 20. The connectors 16 and 18 are mounted within a slot 22 at the head 24 of the base plate 12. The connectors 16 and 18 have arms that extend into the track 22 which allow the connectors 16 and 18 to be mounted to the base 12 and to slide along the head 24. The connectors 16 and 18 of the disclosed embodiment have threaded mounts 26. The mounts 26 thread against the shoe of a power or cutting tool 14, such as for example a circular saw, as illustrated in FIG. 3. The connector 20 includes a threaded mount 28 and a bracket 30. The bracket 30 engages the shoe of the saw 14 and the threaded mount 28 can be adjusted down to hold the saw 14 onto the base plate 12. In the disclosed embodiment, the threaded mount 28 is a threaded stud and a wing nut.

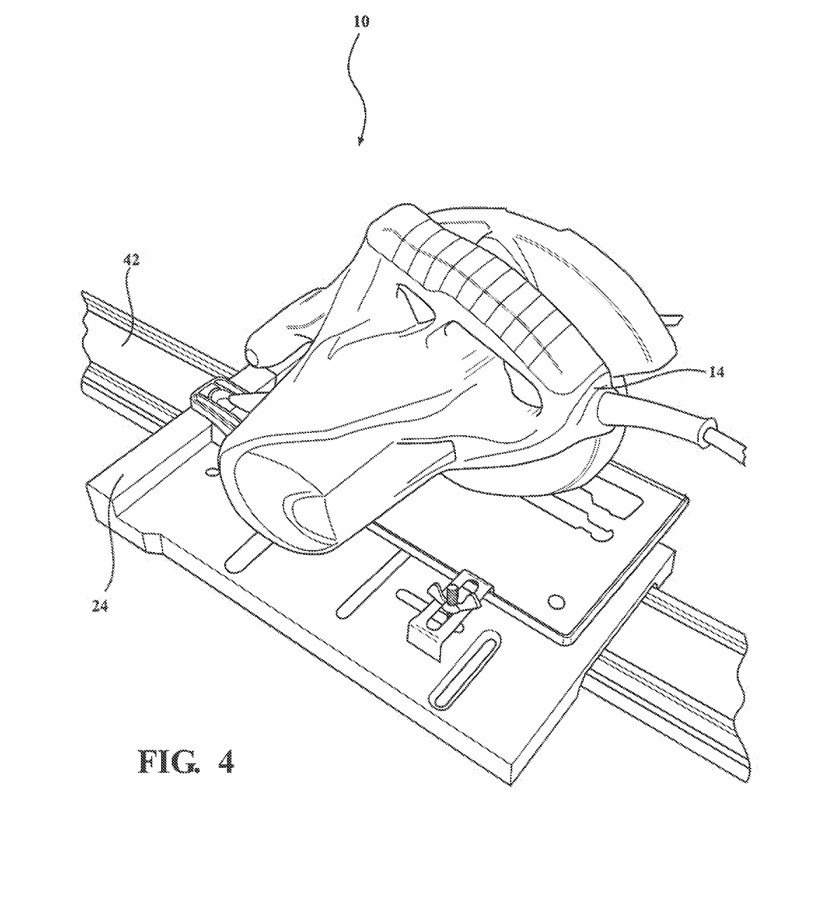

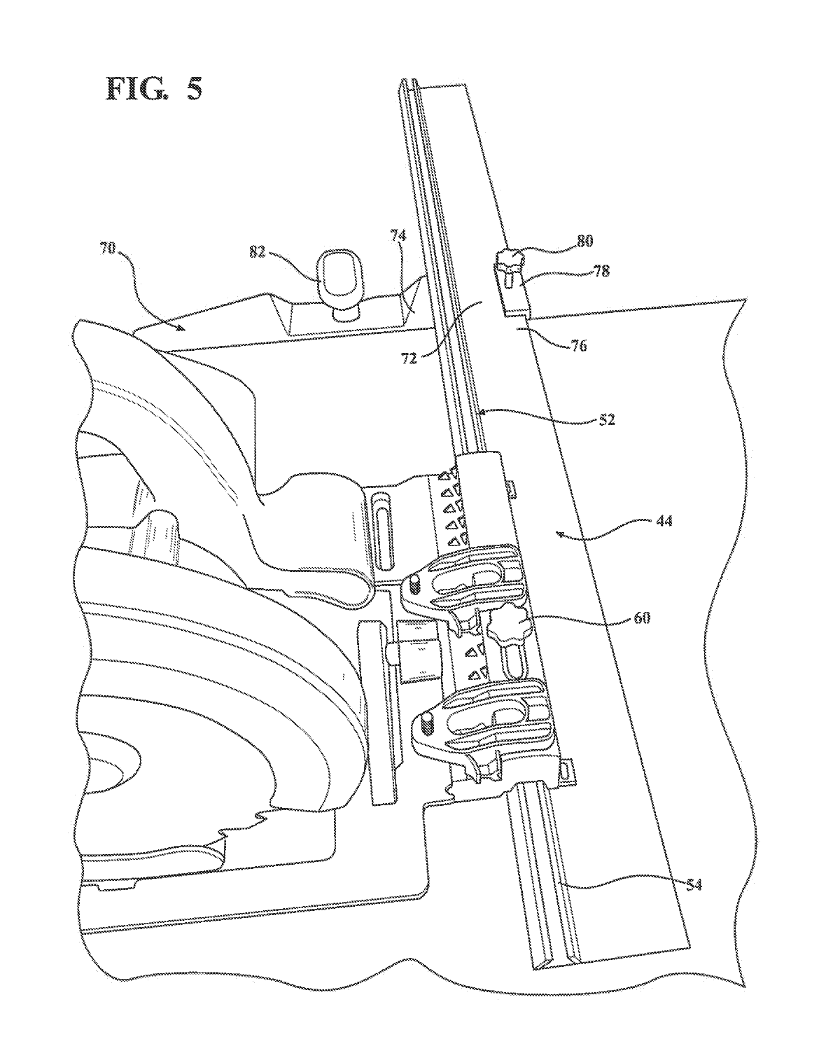

The bottom of the base plate 12 has a guide track that is defined by spaced walls 32 and 34. In the disclosed embodiment, one of the walls is a fixed guide wall 32 and the other wall is an adjustable guide wall 34. It should be appreciated that both walls could be adjustable. The adjustable guide wall includes arms 36 and an indicator 38. The arms 36 are retained with respect to the base plate 12 with fasteners 40. The wall 34 is adjusted to allow the walls 32 and 34 to engage a desired straight edge and allow the guide 10 to be moved along the straight edge. The adjustable wall 34 allows the guide 10 to be used on any desired straight edge, such as for example a four (4) inch board, a commercially available straight edge, etc. With reference to FIG. 4, the base plate 12 is illustrated on a straight edge 42. In the disclosed embodiment, the track is over four (4) inches wide and about one half, ½, inch deep, but as will be appreciated by those of ordinary skill in the art, could have a different size opening, either larger or smaller.

The base 12 also includes a pair of tabs 46 extending from the head portion 24. The tabs 46 are adapted to receive an indicator 48. The indicator 48 lines up with the blade of for example, the circular saw 14 to let the user know where the blade is located which simplifies the alignment of the straight edge.

In use, a cutting tool 14, such as a circular saw 14, is attached to the base 12. The connectors 16 and 18 are slid over the shoe of the cutting tool 14 and the connector 20 is positioned over the shoe and all connectors 16, 18 and 20 are tightened against the shoe. The blade of the tool 14 can be located using the indicator 48. A straight edge 42 is fixed to the work piece. The straight edge 42 for example, could be a piece of wood, a metal ruler, or a commercial straight edge, such as those supplied by applicant under the trademark BORA®. The base 12 is positioned over the straight edge 42 with the straight edge 42 being positioned within the track 22. The base 12 can be moved along the straight edge 42 to cut the work piece in a straight guided line.

The base 12 can also be used as a ripping saw with a rip straight edge 44. The disclosed base plate 12 has a lateral channel 50 that slides over the raised track 52 of the rip straight edge 44. In the disclosed embodiment, the lateral channel 50 and raised track 52 have generally mating angled sidewalls. The angled sidewalls mate to provide a more precise secure connection and provide a more tight connection when the base plate 12 is connected to the raised track 52. This ensures that the base plate 12 doesn't move with respect to the rip straight edge 44. The raised track has a groove 54 that is adapted to receive a locking wedge 56 that includes a locking member 58. The disclosed locking member 58 has a knob 60 and a threaded shaft 62 that is threading into the locking member 58.

It should be appreciated by those of ordinary skill in the art, that other methods could be used to connect the base plate 12 to the rip straight edge 44. For example, the rip straight edge 44 could be bolted or screwed to the base plate 12; or the base plate 12 could have a mating receiver that mates with the profile of the rip straight edge 44, etc. The key is that the base plate 12 be fixed to the rip straight edge 44.

The straight edge 44 also receives a rip guide 70. The rip guide 70 includes a guide way 72. The guide way 72 is defined by a raised wall 74 and a slot 76. The slot has a top surface 78 that extends over the edge of the straight edge 44. A locking member 80 is used to lock the rip guide 70 to the straight edge 44. In the disclosed embodiment, the locking member 80 is a threaded screw with a knob to facilitate the threading of the locking member against the straight edge 44. A handle 82 is provided on the straight edge 44 to facilitate movement of the saw 14 along the material to be ripped.

In use, the head 24 is positioned over the channel 50 with the wedge 56 inserted into the channel 50. The guide way 72 of the rip guide 70 is positioned over the straight edge 44 and the locking member 80 is threaded onto the straight edge 44 to lock the rip guide 70 onto the straight edge 44. The saw 14 is adjusted on the straight edge 44 to proper position to make the rip cut. Once positioned, the base 12 can be locked onto the straight edge 44 by engaging the locking member 80. The handle 82 can then be grasped and the saw moved along the work piece to rip a section from the material.

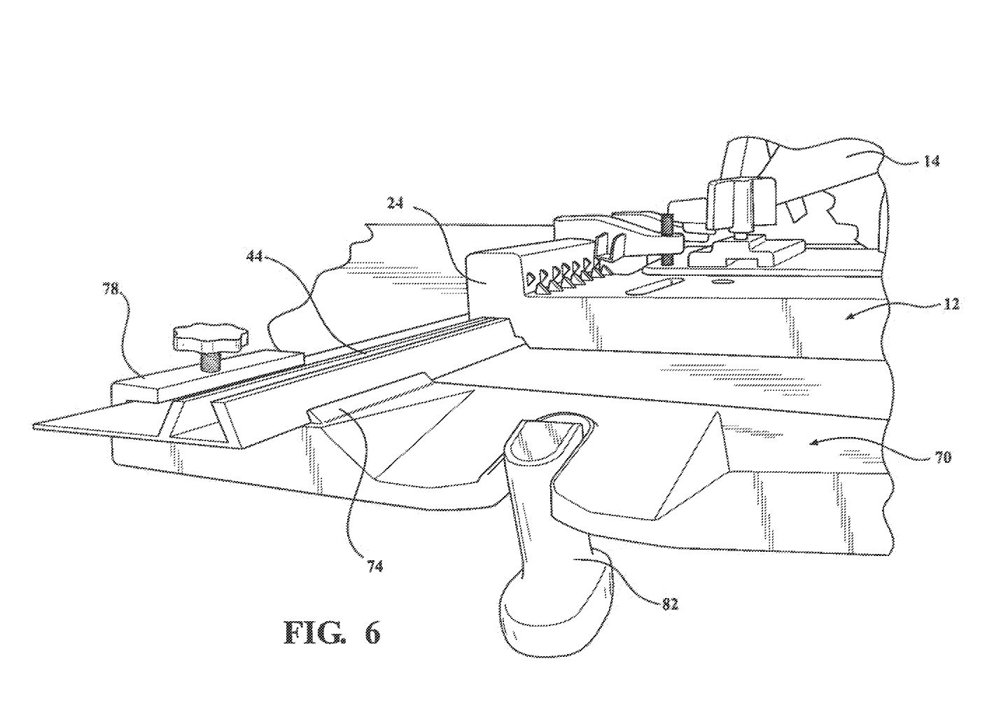

As disclosed in FIG. 6, the handle 82 can be mounted to rotate with respect to the rip guide 70. Rotating the handle 82 allows the base 12 to be moved over the rip guide 70 to allow very narrow portions of the material to be ripped.

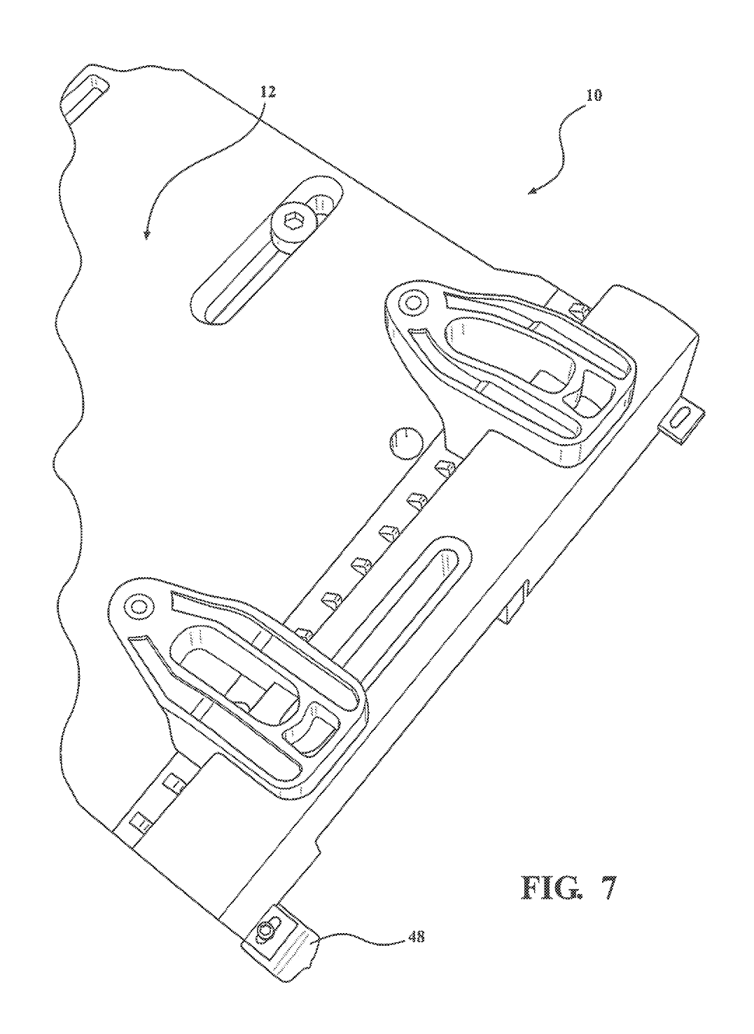

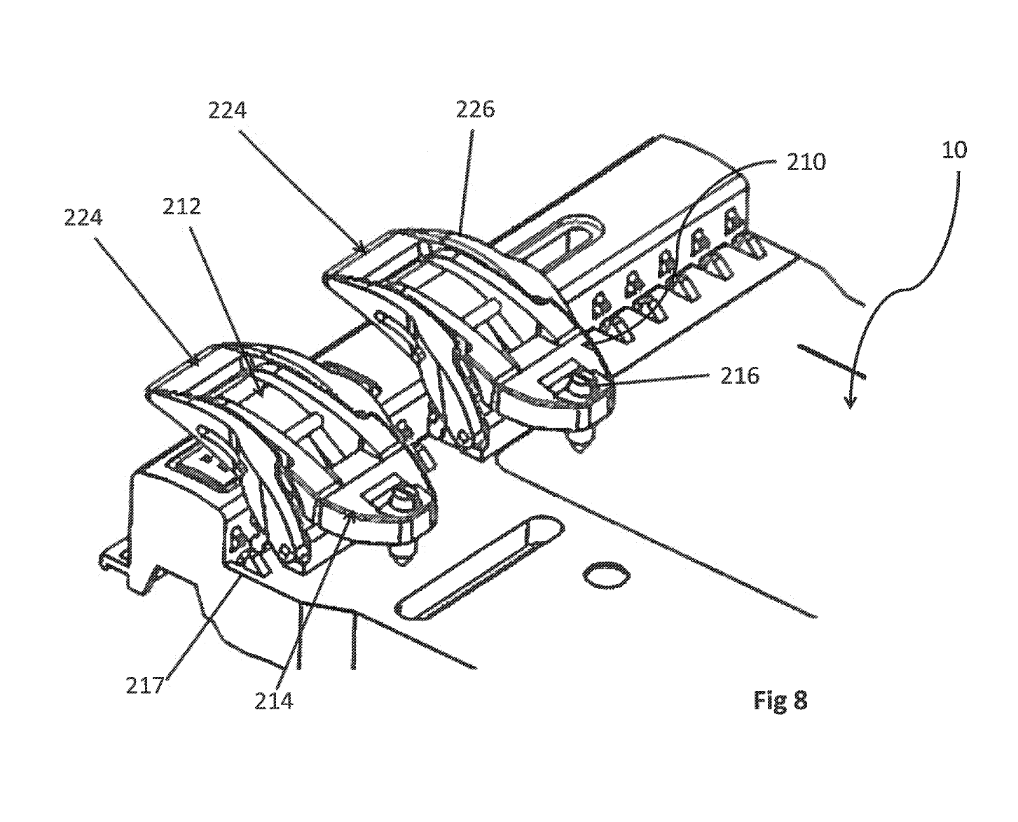

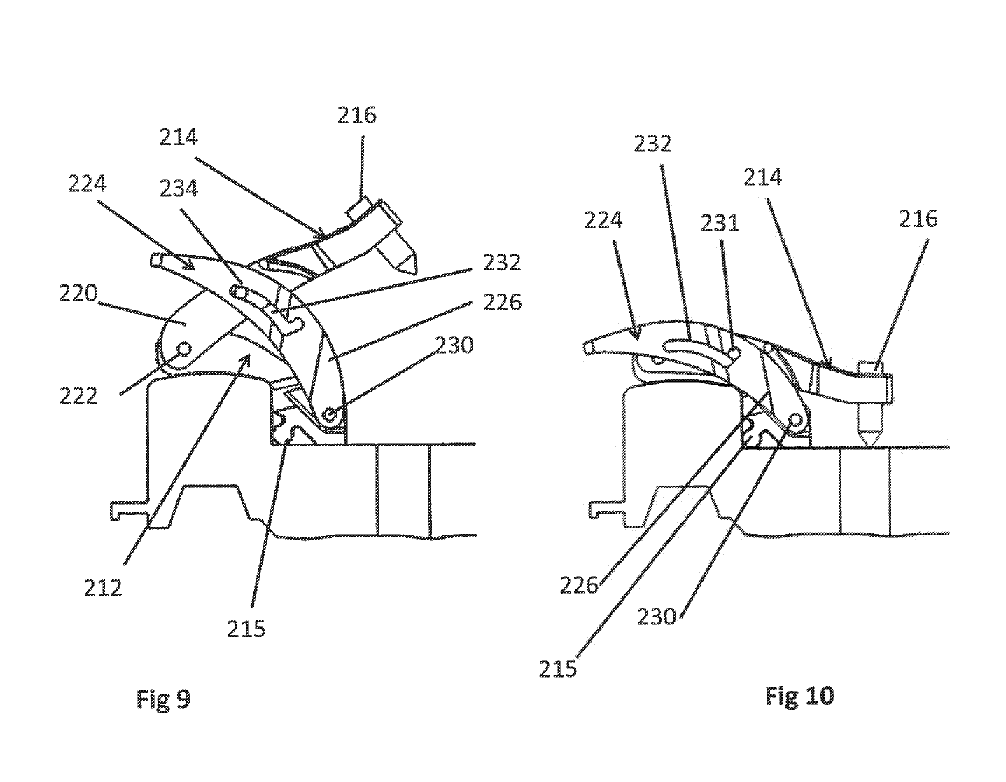

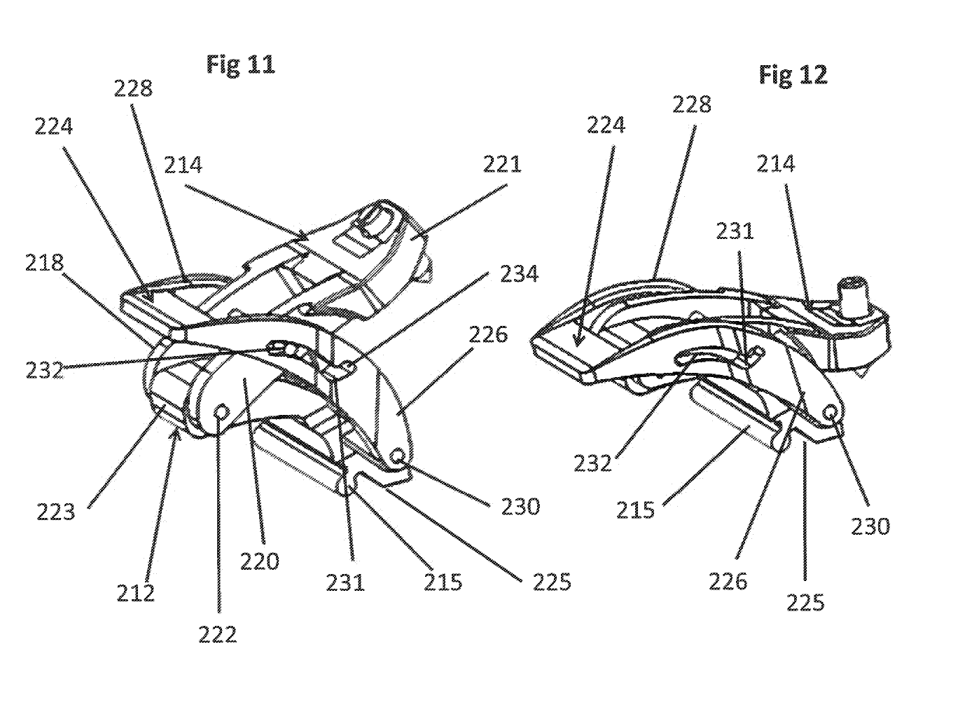

With reference to FIGS. 8 through 12, a further embodiment of the locking assembly of the present invention is shown generally at 210. The locking assembly 210 has a base 212 that is mounted to the saw plate guide 10. In the disclosed embodiment, the base 212 has a first end 223 and a second end 225 with a mounting tab 215 at the second end 225. The mounting tab 215 is received within a mounting tab receiver or mating mounting slot 217. The tab 215 slides within the receiver 217, so that it can be moved along the receiver to adjust the lateral position of the locking assembly 210. In the disclosed embodiment, the receiver is defined by a plurality of protrusions, but as will be appreciated by those of ordinary skill in the art, the receiver could be defined as a continuous slot formed into the saw plate guide 10.

A locking head 214 is pivotally mounted to the base 212. A locking finger 216 is threaded into the free end of the locking head 214. The locking head has opposed arms 218 and 220 that extend from the front end 221 to the first end 223 of the base 212. A shaft 222 extends through the arms 218 and 220 and the first end 223 of base 212. The locking head 214 pivots with respect to the base 212 about the shaft 222. A lock actuator or handle 224 is pivotally mounted to the base 212 at pivotal connections 230 at the second end 225 of base 212. The lock actuator 224 has opposed legs 226 and 228. The legs 226 and 228 are positioned adjacent the opposed arms 218 and 220. Legs 226 and 228 pivot with respect to the arms 218 and 220 at pivot points 230.

A slot 232 is formed in each of the legs 226 and 228. The slot 232 extends longitudinally along each leg 226 and 228 and ends in a general right angle notch 231. A guide pin 234 extends through the arms 218 and 220 of the locking head 214 and protrudes through the slots 232 of each leg 226 and 228.

In operation, the actuator 224 is depressed which causes the locking head 214 to lower. The guide pin 234 is forced to slide in the slots 232. Since the guide pin 234 extends through the locking head 214, the locking head 214 is forced downward. When the pin 234 reaches the end of slot 232, it is received within the notch 231 to lock it from further movement. The locking finger 216 engages the shoe of the saw to fix the saw to the saw guide plate 10. Since the locking finger 216 is threaded, it can be adjusted to properly engage the shoe. To release the shoe, the actuator 224 is raised to release the pin 234 from the notch 231 and allow the pin 234 to enter the slot 232 and allow the actuator 224 to be fully raised.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A cutting tool guide system comprising:
a base plate having a top surface and a bottom surface, said base plate top surface including connection points for connecting a power tool to said base plate top surface;
a track extending longitudinally along said bottom surface of said base plate, said track being defined by first and second spaced walls, at least one of said walls being movable with respect to said other wall;
whereby a power tool can be attached to said base plate and said base plate can be positioned upon a straight edge, said at least one wall being movable adjacent said straight edge with said straight edge being adjacent said opposite wall, said base being movable along said straight edge to make a straight cut in a piece of material.

2. The cutting tool guide system of claim 1, wherein said connection points include:
a locking base having a first end and a second end, said second end mounted to said cutting tool guide system;
a locking head pivotally mounted to said base, said locking head having a free end and opposed arms extending from said free end of said locking head to said first end of said base;
a first pivot connection connecting said arms and said first end of said base, said locking head pivots with respect to said base about said first pivot connection;
a lock actuator pivotally mounted through a second pivot connection to said base at said second end of said base; said lock actuator includes opposed legs, said legs positioned adjacent said opposed arms and pivotable with respect to said arms;
a slot formed in each of said legs, said slot extending generally longitudinally along each leg ending in a general right angle notch;
a guide pin extending through said arms of said locking head and protruding through said slots of each leg;
whereby said locking head is moved to said locking position by depressing said lock actuator and sliding said guide pin in said slots and lowering said locking head, said pin being received in said notch to lock it from further movement and lock said locking head in said locked position, said locking head being released by raising said actuator to release said pin from said notch and allow said pin to enter said slot allowing said actuator to be raised.

3. The cutting tool guide system of claim 2, wherein said connection points includes a locking tab receiver,
said base of said locking assembly having a mounting tab that is received within said locking tab receiver, said tab slides within said receiver so that it can be moved along said receiver to adjust the lateral position of said locking assembly.

4. The cutting tool guide system of claim 2, said locking head having a locking finger mounted at said free end.

5. A locking assembly for locking a tool to a tool guide, said locking assembly comprising:
a locking base having a first end and a second end, said second end adapted to be mounted to a tool guide;
a locking head pivotally mounted to said base, said locking head having a free end and opposed arms extending from said free end of said locking head to said first end of said base;
a first pivot connection connecting said arms and said first end of said base, said locking head pivots with respect to said base about said first pivot connection;
a lock actuator pivotally mounted through a second pivot connection to said base at said second end of said base; said lock actuator includes opposed legs, said legs positioned adjacent said opposed arms and pivotable with respect to said arms;
a slot formed in each of said legs, said slot extending generally longitudinally along each leg ending in a general right angle notch;
a guide pin extending through said arms of said locking head and protruding through said slots of each leg;
whereby said locking head is moved to said locking position by depressing said lock actuator and sliding said guide pin in said slots and lowering said locking head, said pin being received in said notch to lock it from further movement and lock said locking head in said locked position, said locking head being released by raising said actuator to release said pin from said notch and allow said pin to enter said slot allowing said actuator to be raised.

6. The cutting tool guide system of claim 5, wherein said connection points includes a locking tab receiver,
said base of said locking assembly having a mounting tab that is received within said locking tab receiver, said tab slides within said receiver so that it can be moved along said receiver to adjust the lateral position of said locking assembly.

7. The cutting tool guide system of claim 5, said locking head having a locking finger mounted at said free end.
